(19) United States
(12) Patent Application Publication
(10) Pub. No.: US 2004/0119258 A1
(43) Pub. Date: Jun. 24, 2004

(54) Baby walker

(76) Inventor: Ted-Hwan Yoo, Seoul (KR)

Correspondence Address: McGuire Woods LLP, Suite 1800, 1750 Tysons Boulevard, McLean, VA, 22102, US

(21) Appl. No.: 10/321,716

(22) Filed: Dec. 18, 2002

(51) Int. Cl. B62B 7/00

(52) U.S. Cl. 280/87.051; 280/642

(57) ABSTRACT

A baby walker is disclosed, which can adjust the height to a height of a dining table for an adult and has a stable structure without any movement or shaking after the adjustment of the height. The baby walker includes a foldable height adjusting unit provided in a lower body to lift the lower body by a predetermined height. The foldable height adjusting unit includes first and second supporting rods intersecting each other and having first ends respectively fixed into clamp units of the lower body, and a rotational joint for fixing the intersection parts of the first and second supporting rods, one of the supporting rods being provided with a foldable joint between the corresponding clamp unit and the rotational joint.

### BACKGROUND OF THE INVENTION

1. Field of the Invention

The present invention relates to a baby walker, and more particularly to, a baby walker of which height can simply be adjusted to that of a dining table without greatly changing its structure.

2. Discussion of the Related Art

A structure of a related art baby walker, as shown in FIG. 1 and FIG. 2, includes an upper body 1 provided with a saddle 3 to stably sit a baby in, a lower body 2 provided with a plurality of wheels 4, and an X-shaped supporting die 5 positioned between the upper body and the lower body and adjustable in the height by a predetermined degree. The X-shaped supporting die 5 includes a supporting shaft 6 and supporting rods 7. The supporting shaft 6 includes annular elements 6a and 6b which are coupled together to be rotatable in the axial direction. The supporting rods 7 are respectively fitted into the annular elements 6a and 6b of the supporting shift 6.

Each of the supporting rods 7 have an end which is fixed to the upper body or the lower body by means of clamp units 8a and 8b, and the other end which is fitted into a supporting rod slide groove 10 formed in the lower body 2 or a height adjusting detent 9 formed below the upper body 1. The height adjusting detent 9 is slidably fitted into a height adjusting detent guide 11 formed below the upper body 1.

The related art baby walker is constructed in such a manner that its height is adjusted by adjusting an angle of the X-shaped supporting die 5 to be suitable for the body size of a baby using the height adjusting detent 9.

However, the related art baby walker has a disadvantage that there is limitation in adjusting the height as the height is adjusted within the range of the lower body 2 of which size is limited. If the upper body 1 is lifted by extending the length of the X-shaped supporting die to lift the baby walker to the height of a dining table for an adult, the upper body 1 and the lower body 2 are not folded completely. Therefore, the length of the lower body 2 should be increased. For this reason, if the related art baby walker has a structure that can adjust its height to a height of a dining table for an adult, the volume of the baby walker becomes too large.

In order to solve the above problems of the related art, Korean Utility Model Registration No. 1994-5148, as shown in FIG. 3 and FIG. 4, discloses a baby walker having a structure in which a height adjustment range is increased by connecting X-shaped supporting dies in the vertical direction, thereby using the baby walker as a dining table chair for a baby.

In the structure as shown in FIG. 3 and FIG. 4, an upper body 1 is provided with a saddle 3 and a lower body 2 is provided with wheels 4. Two X-shaped supporting dies 5 are vertically formed the upper body 1 and the lower body 2. Supporting shafts 6 are vertically formed in the intersection between supporting rods 7. The two X-shaped supporting dies 5 are connected to each other by another supporting shafts 16.

The two X-shaped supporting dies 5 are foldable by means of annular elements 6a, 6b and 16a, 16b that are rotatable axially with respect to each other.

One of the supporting rods 7 provided at a lower end of one of the X-shaped supporting dies 5 is connected to a clamp unit 8 of the lower body 2 while the other rod 7 is connected to a height adjusting detent 9 formed in the lower body 2.

If a press switch at an upper end of the height adjusting detent 9 is pressed and pulled backwardly, the upper body 1 is moved upwardly by the operation of the X-shaped supporting die. On the other hand, if the press switch is pressed and pulled forwardly, the upper body 1 is moved downwardly. If a user releases the press switch after adjusting the height, the upper rod 1 is caught in a detent groove 19 and fixed therein. Therefore, the baby walker as shown in FIG. 3 and FIG. 4 has an advantage in that the height can be adjusted (approximately, two times) without increasing the volume of the baby walker in comparison with the baby walker as shown in FIG. 1 and FIG. 2.

However, the baby walker of the structure as shown in FIG. 3 and FIG. 4 still has disadvantages. That is, since the supporting rods 16 are suspended on the space at the middle position of the X-shaped supporting dies, the baby walker is apt to move and shake, thereby lacking stability when the height is adjusted upwardly.

Further, the X-shaped supporting dies are not fully covered but exposed between the upper body and the lower body when the baby walker is folded. This increases the volume of the baby walker and causes inconvenience in carrying it.

### SUMMARY OF THE INVENTION

The present invention is directed to a baby walker that substantially obviates one or more of the problems due to limitations and disadvantages of the related art.

An object of the present invention is to provide a baby walker that can adjust the height to a height of a dining table for an adult and has a stable structure without any movement or shaking after the adjustment of the height, along with a small volume.

Additional features and advantages of the invention will be set forth in the description which follows, and in part will be apparent from the description, or may be learned by practice of the invention. The objectives and other advantages of the invention will be realized and attained by the scheme particularly pointed out in the written description and claims hereof as well as the appended drawings.

To achieve these and other advantages and in accordance with the purpose of the present invention, as embodied and broadly described, a baby walker includes an X-shaped supporting die for adjusting a distance between an upper body and a lower body by a predetermined distance, and a foldable height adjusting unit provided at a lower part of the lower body, for raising the lower body by a predetermined height.

The foldable height adjusting unit is incorporated in the lower body not to disturb the natural operation of the baby walker but to improve the appearance of the baby walker, and is exposed to the outside only if the height adjustment is necessary.

According to the present invention, a baby walker that can adjust the height between an upper body provided with a saddle and a lower body provided with wheels, includes a foldable height adjusting unit provided in the lower body to lift the lower body by a predetermined height.

The foldable height adjusting unit is incorporated in the lower body.

Further, the foldable height adjusting unit includes first and second supporting rods intersecting each other and having first ends respectively fixed into clamp units of the lower body, and a rotational joint for fixing the intersection parts of the first and second supporting rods, one of the supporting rods being provided with a foldable joint between the corresponding clamp unit and the rotational joint.

The foldable height adjusting unit includes first and second supporting rods intersecting each other and fixed together in the intersection state by a rotational joint, one end of the first supporting rod being fixed to the clamp unit of the lower body and one end of the second supporting rod being fixed in a height adjusting detent which slides by a predetermined distance in the lower body.

It is to be understood that both the foregoing general description and the following detailed description are exemplary and explanatory and are intended to provide further explanation of the invention as claimed.

### BRIEF DESCRIPTION OF THE ATTACHED DRAWINGS

The invention will be described in detail with reference to the following drawings in which like reference numerals refer to like elements wherein:

FIG. 1 is a perspective view of a related art baby walker;

FIG. 2 is a side view of the baby walker of FIG. 1;

FIG. 3 is a perspective view of another related art baby walker that can adjust its height;

FIG. 4 is a side view of the baby walker of FIG. 3;

FIG. 5 is a perspective view of a height adjustable baby walker according to the preferred embodiment of the present invention;

FIG. 6 is a side view of the baby walker of FIG. 5, in which a height adjustment supporting die is incorporated in a lower body;

FIG. 7 illustrates another height adjustment supporting die according to the present invention;

FIG. 8 is a left-side view illustrating a structure of a height adjusting detent of the height adjustment supporting die as shown in FIG. 7; and

FIG. 9 is a view illustrating other height adjustment supporting die according to the present invention.

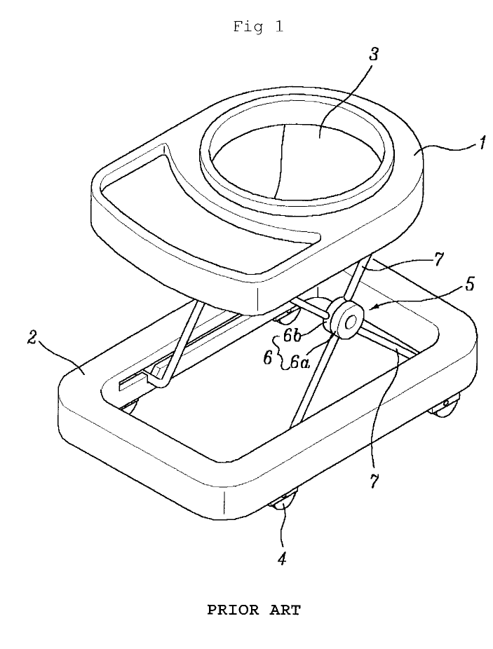

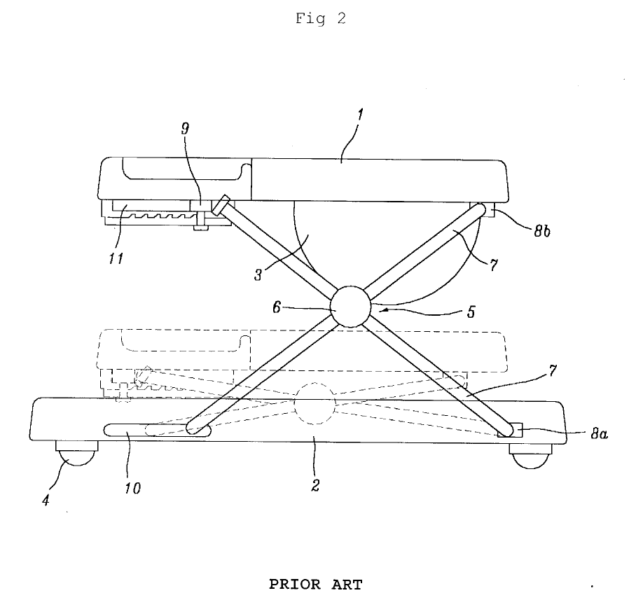

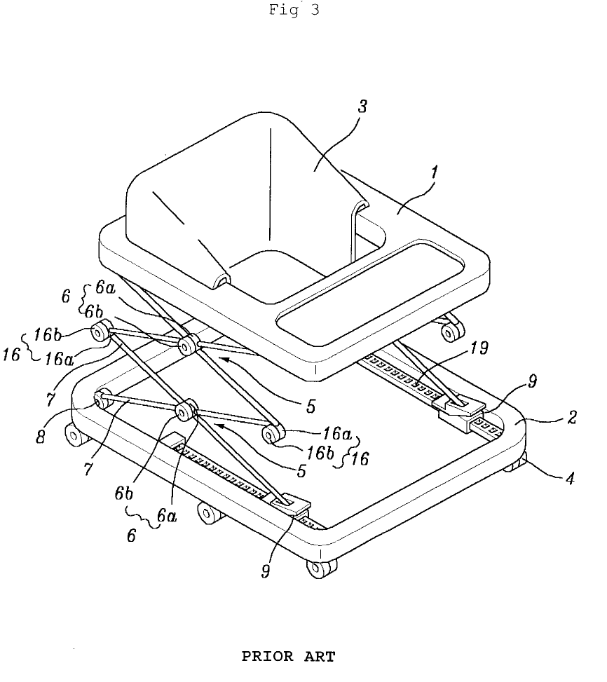

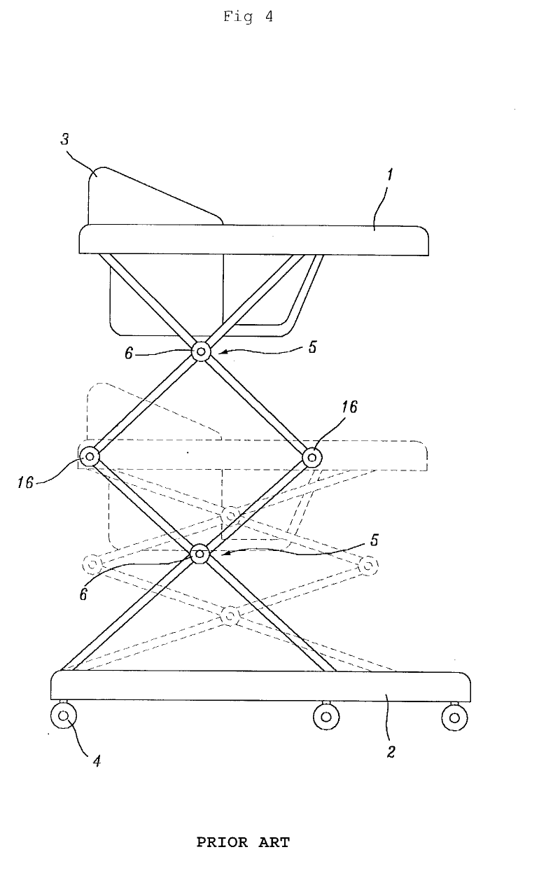

### DETAILED DESCRIPTION OF THE PREFERRED EMBODIMENTS

Reference will now be made in detail to the preferred embodiments of the present invention, examples of which are illustrated in the accompanying drawings.

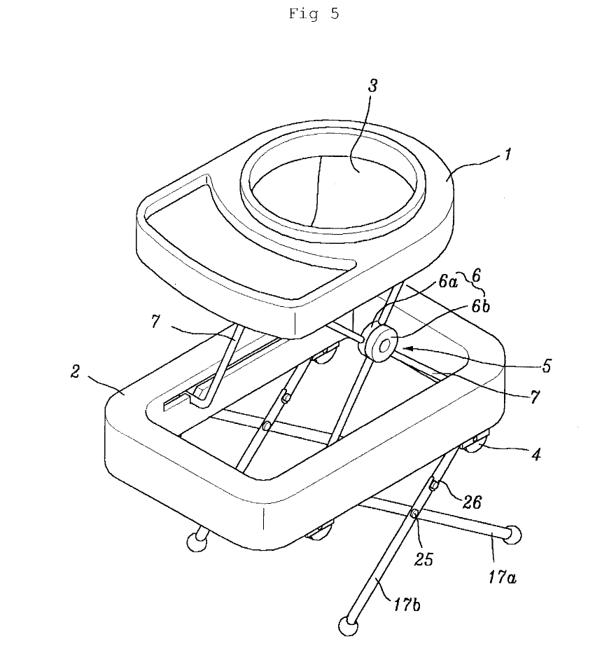

A baby walker according to the present invention will be described with reference to FIG. 5 to FIG. 9 in detail.

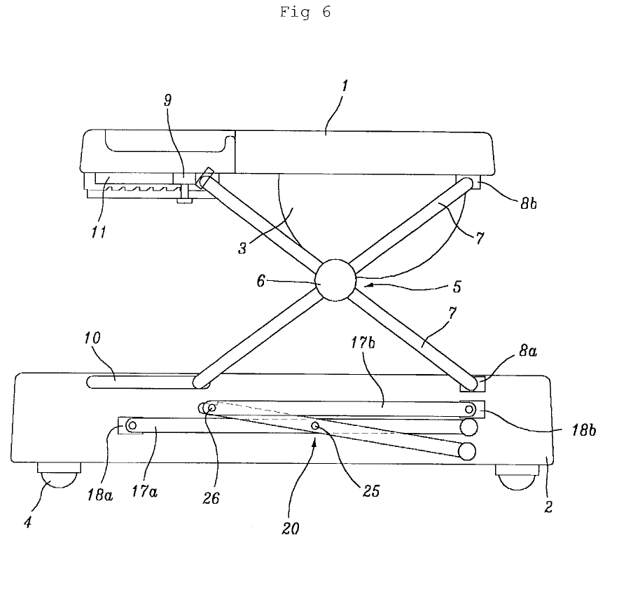

Referring to FIG. 5 and FIG. 6, a height-adjustable baby walker according to the present invention includes an upper body 1 provided with a saddle 3 for sitting a baby in, a lower body 2 provided with a plurality of wheels 4, and an X-shaped supporting die 5 provided between the upper and lower bodies for adjusting the height of the baby walker.

The X-shaped supporting die 5 includes a supporting shaft 6 formed of annular elements 6a, 6b, which are coupled with each other to be rotatable in the axial direction with respect to each other, and supporting rods 7 fitted into the annular elements 6a, 6b of the supporting shaft.

Each of the supporting rods 7 have an end which is fixed to the upper body or the lower body by means of clamp units 8a and 8b, and the other end which is fitted into a supporting rod slide groove 10 formed in the lower body 2 or a height adjusting detent 9 formed below the upper body 1. The height adjusting detent 9 is slidably fitted into a height adjusting detent guide 11 formed below the upper body 1.

Meanwhile, a foldable height adjusting unit 20 is provided at a lower part of the lower body. The foldable height adjusting unit 20 includes a supporting rod 17a having one end fixed into clamp units 18a of the lower body 2, and a supporting rod 17b having one end fixed into a clamp unit 18b of the lower body. The supporting rods 17a, 17b intersect each other and are fixed by a rotational joint 25. The supporting rod 17b is provided with a foldable joint 26 between the clamp unit 18b and the rotational joint 25. When the joint 26 is straightened, it is not folded even in spite of a load applied from the upper part of the baby walker. If the supporting rod 17b is folded from the opposite side with respect to the joint 26 formed in the supporting rod 17b, the supporting rod 17a fixed to the rotational joint 25 moves toward the lower body 2 and is folded within the lower body 2.

Therefore, if the foldable height adjusting unit 20 of the present invention is provided inside the lower part of the lower body 2 as shown in FIG. 5 and FIG. 6, it is possible to provide a structure that can simply lift the baby walker up to the height of a dining table for an adult without any change in the size of the baby walker. Further, this structure does not cause shaking or movement even when the height is adjusted upwardly. Moreover, since the foldable height adjusting unit is provided inside the lower body, it is not noticed outside, thereby preventing damage of the appearance and obtaining stability of the structure.

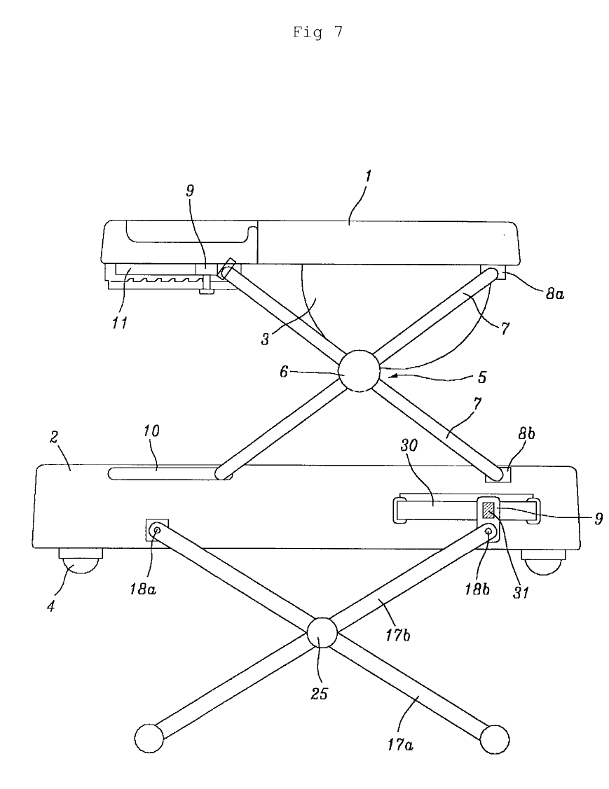

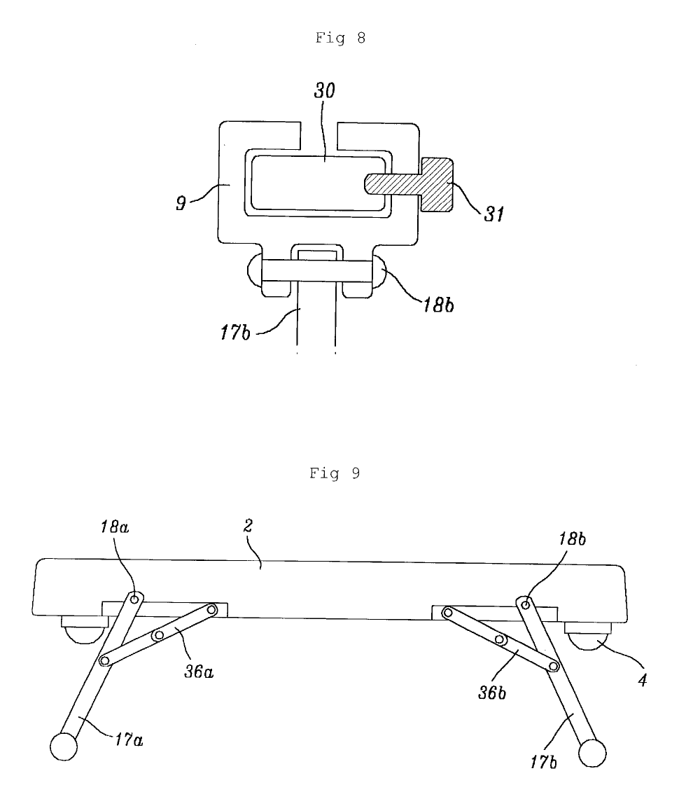

FIG. 7 and FIG. 8 shows a foldable height adjusting unit according to another embodiment of the present invention. In FIG. 7 and FIG. 8, supporting rods 17a, 17b are provided to intersect each other by a rotational joint 25 and respectively fixed into clamp units 18a, 18b of a lower body 2. The clamp unit 18b, into which the supporting rod 17b is fixed, is connected to a height adjusting detent 9. The height adjusting detent 9 is provided to slide along a height adjusting detent guide 30 formed in the longitudinal direction of the lower body 2. The height adjusting detent 9 is provided with a press switch 31 for fixing the height adjusting detent 9 to the guide 30.

According to other embodiment of the present invention, as shown in FIG. 9, a foldable height adjusting unit has a structure in which supporting rods 17a, 17b, which are respectively fixed into clamp units 18a, 18b at a lower part of the lower body 2, are foldable via foldable joints 36a, 36b.

As aforementioned, the baby walker according to the present invention has the following advantages.

Since the foldable height adjusting unit is provided in the internal space of the lower body to lift and support the lower body by a predetermined height, the user can optionally adjust the height of the baby walker up to a dining table for an adult while keeping the volume of the baby walker compactly. Especially, it is possible to provide a stable structure that does not cause any shaking or movement even after the height adjustment. Further, the baby walker can be used multi-functionally as a natural baby walker and as a dining table chair for a baby by adjusting the height if necessary.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A baby walker that can adjust the height between an upper body provided with a saddle and a lower body provided with wheels, comprising:
a foldable height adjusting unit provided in the lower body to lift the lower body by a predetermined height.

2. The baby walker according to claim 1, wherein the foldable height adjusting unit includes first and second supporting rods intersecting each other and having first ends respectively fixed into clamp units of the lower body, and a rotational joint for fixing the intersection parts of the first and second supporting rods, one of the supporting rods being provided with a foldable joint between the corresponding clamp unit and the rotational joint.

3. The baby walker according to claim 1, wherein the foldable height adjusting unit includes first and second supporting rods intersecting each other and fixed together in the intersection state by a rotational joint, one end of the first supporting rod being fixed to the clamp unit of the lower body and one end of the second supporting rod being fixed in a height adjusting detent which slides by a predetermined distance in the lower body.

4. The baby walker according to claim 2 or claim 3, wherein the foldable height adjusting unit is incorporated inside the lower body.
